(19) United States
(12) Patent Application Publication
(10) Pub. No.: US 2026/0238153 A1
(43) Pub. Date: Aug. 13, 2026

(54) CONTROLLING SPEED OF POWER TOOL

(71) Applicant: MIRKA LTD, Jepua (FI)

(72) Inventor: Tomas SÖDERGÅRD, Nykarleby (FI)

(21) Appl. No.: 19/140,284

(22) PCT Filed: Dec. 18, 2023
(86) PCT No.: PCT/FI2023/050710

§ 371 Date: Jun. 17, 2025

(30) Foreign Application Priority Data
Dec. 20, 2022 (FI) 20226132

(51) Int. Cl. H02P 29/028; B25F 5/00; H02P 29/10

(52) U.S. Cl. CPC H02P 29/028; B25F 5/001; H02P 29/10

(57) ABSTRACT

A method for controlling motor speed of a power tool, comprising measuring at least one current value of current output from a power switching network connected to a motor of the power tool, measuring a speed of the motor, and determining, if the measured at least one current value has met a first speed dependent current limit setting, determining a second speed dependent current limit setting, and controlling the power switching network to drive the motor at a target speed corresponding to the second speed dependent current limit.

### TECHNICAL FIELD

The present invention relates controlling motor speed of a power tool.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

EP2027969A1 discloses that in “idle speed” mode the speed of motor is regulated at an idle speed and in “sanding speed” mode the speed of motor is regulated based on the position of speed potentiometer. Regulating the speed of motor based on the position of the speed potentiometer necessitates a user to adjust the speed potentiometer at the same time as the sanding is performed, which may lead to unintentionally adjusting the speed potentiometer or an incorrect adjustment of the speed potentiometer. Additionally, the sanding may be disturbed by the adjustment, for example if the user stops moving the sander and/or pressure applied to the sander by the user is changed.

### SUMMARY

The scope of protection sought for various embodiments of the invention is set out by the independent claims. The embodiments, examples and features, if any, described in this specification that do not fall under the scope of the independent claims are to be interpreted as examples useful for understanding various embodiments of the invention.

According to some aspects, there is provided the subject matter of the independent claims. Some further aspects are defined in the dependent claims. The embodiments that do not fall under the scope of the claims are to be interpreted as examples useful for understanding the disclosure.

According to a first aspect there is provided a method comprising:
measuring at least one current value of current output from a power switching network connected to a motor of the power tool;
measuring a speed of the motor; and
   if the measured at least one current value has met a first speed dependent current limit setting, determining a second speed dependent current limit setting; or
   determining a power of the motor based on the measured at least one current value and the measured speed, and, if the determined power of the motor has met a first speed dependent power limit setting, determining a second speed dependent power limit setting; and
controlling the power switching network to drive the motor at a target speed corresponding to the second speed dependent current limit setting or the second speed dependent power limit setting.

According to a second aspect there is provided a power tool for controlling motor speed of the power tool, said power tool comprising a controller connected to a current sensor, a speed sensor and a power switching network for driving a motor, wherein the power tool is configured to:
measure, by the controller, at least one current value of current output from a power switching network connected to a motor of the power tool;
measure, by the controller, a speed of the motor; and
   determine, by the controller, if the measured at least one current value has met a first speed dependent current limit setting, and if the measured at least one current value has met the first speed dependent current limit setting, determining a second speed dependent current limit setting; or
   determine, by the controller, a power of the motor based on the measured at least one current value and the measured speed, and, if the determined power of the motor has met a first speed dependent power limit setting, determining a second speed dependent power limit setting; and
control, by the controller, the power switching network to drive the motor at a target speed corresponding to the second speed dependent current limit setting or the second speed dependent power limit setting.

According to a third aspect there is provided an apparatus comprising:
means for measuring at least one current value of current output from a power switching network connected to a motor of a power tool;
means for measuring a speed of the motor; and
   means for determining, if the measured at least one current value has met a first speed dependent current limit setting and if the measured at least one current value has met the first speed dependent current limit setting, determining a second speed dependent current limit setting; or
   means for determining a power of the motor based on the measured at least one current value and the measured speed, and, if the determined power of the motor has met a first speed dependent power limit setting, determining a second speed dependent power limit setting; and
means for controlling the power switching network to drive the motor at a target speed corresponding to the second speed dependent current limit setting or the second speed dependent power limit setting.

According to one or more further aspects the one or more of the first, second and third aspects comprise one or more of the following:
determining the first speed dependent current limit setting or the first speed dependent power limit setting based on the measured speed of the motor;
using the second speed dependent current limit setting or the second speed dependent power limit setting for monitoring current output by the power switching network;
increasing the target speed of the motor if the measured at least one current value has met the first speed dependent current limit setting;
increasing the target speed of the motor if the determined power has met the first speed dependent power limit setting;
decreasing the target speed of the motor if the measured at least one current value does not meet the first speed dependent current limit setting;
decreasing the target speed of the motor if the determined power does not meet the first speed dependent power limit setting;
maintaining the target speed above an idle speed, when the motor is loaded;
controlling the power switching network to drive the motor at an idle speed if the measured at least one current value has not met a threshold value for the current;
controlling the power switching network to drive the motor based on the first speed dependent current limit setting, if the measured at least one current value has met the threshold value for the current;
controlling the power switching network to drive the motor based on the first speed dependent power limit setting, if the determined power value has met a threshold value for the power;
determining a user speed setting based on user input; maintaining the target speed, if the measured speed of the motor has reached the user speed setting;
selecting a motor speed control mode to be a mode based on speed dependent current limit settings from at least two motor speed control modes for the motor based on a user input received via an operating panel of the power tool or a user input over a wireless connection;
selecting a motor speed control mode to be a mode based on speed dependent power limit settings from at least two motor speed control modes for the motor based on a user input received via an operating panel of the power tool or a user input over a wireless connection;
each of the first speed dependent current limit setting and the second speed dependent current limit setting comprise a range of current values between a higher current limit and a lower current limit;
each of the first speed dependent power limit setting and the second speed dependent power limit setting comprise a range of power values between a higher power limit and a lower power limit;
selecting the second speed dependent current limit setting from more than one speed dependent current limit settings based on a comparison of distances between a range of current values of the second speed dependent current limit settings and the measured at least one current value;
a slope of the first speed dependent current limit setting and the second speed dependent current limit setting is decreasing, with increasing speed of the motor.

At least some of the embodiments provide that a user of a power tool does not have to control the speed via the operating panel of the power tool, but the speed may be decreased and increased based on changing the load applied on the power tool.

### BRIEF DESCRIPTION OF THE DRAWINGS

For a more complete understanding of example embodiments of the present invention, reference is now made to the following descriptions taken in connection with the accompanying drawings in which:

FIG. 1 illustrates a power tool in accordance with at least some embodiments;

FIGS. 2 and 3 illustrate block diagrams for power tools in accordance with at last some embodiments;

FIG. 4 illustrates a method for controlling speed of a motor of a power tool in accordance with at least some embodiments;

FIG. 5 illustrates a method for controlling speed of a motor of a power tool in accordance with at least some embodiments;

FIG. 6 illustrates an example for controlling speed of a motor of a power tool in accordance with at least some embodiments;

FIG. 7 illustrates an example of speed dependent current limit setting and measured current values at defined speeds of a motor of a power tool in accordance with at least some embodiments;

FIG. 8 illustrates examples of speed dependent settings in accordance with at least some embodiments; and

FIG. 9 illustrates an example of controlling a power switching network to drive a motor at a target speed corresponding to a speed dependent current limit in accordance with at least some embodiments.

### DETAILED DESCRIPTION OF SOME EXAMPLE EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Identical or corresponding functional and structural elements which appear in the different drawings are assigned the same reference numerals. When the words first and second are used to refer to different elements, it is to be understood that this does not necessarily imply or mean that the first and second elements are somehow structurally substantially different elements or that their dimensions are substantially different unless specifically stated.

It should be noted that in the following, numeric values for dimensions are presented using comma for separating decimals.

There is provided method for controlling motor speed of a power tool, comprising measuring at least one current value of current output from a power switching network connected to a motor of the power tool, measuring a speed of the motor, and determining, if the measured at least one current value has met a first speed dependent current limit setting, and if the measured at least one current value has met the first speed dependent current limit setting, determining a second speed dependent current limit setting, and controlling the power switching network to drive the motor at a target speed corresponding to the second speed dependent current limit. As an alternative to the current-based approach, where speed dependent current limit settings are used, speed dependent power limit settings may be applied. Therefore, thanks to the speed dependent current limit setting and speed dependent power limit setting the user does not have to control the speed via the operating panel of the power tool, but the speed may be decreased and increased based on changing the load applied on the power tool.

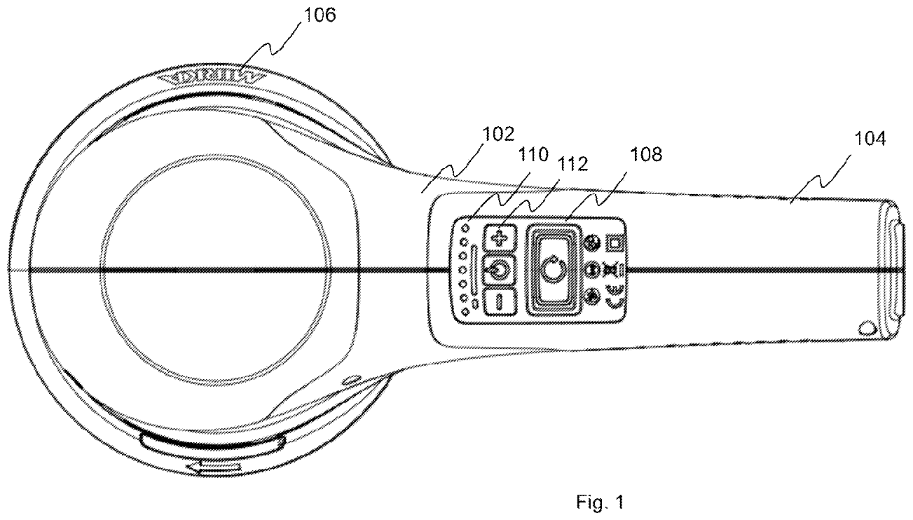

FIG. 1 illustrates a power tool in accordance with at least some embodiments. Examples of power tools comprise at least polishers, sanders, grinders, screwdrivers, impact drivers, drills, circular saws, chain saws or jack hammers. The power tool is illustrated from above. The power tool comprises a housing 102 and a motor arranged inside the housing. The motor comprises an output shaft for connecting tools and/or accessories (not visible) to be driven by the output shaft. In the illustrated example the housing has a pass-through below the power tool, thus on a side of the power tool that is opposite to a viewing direction of FIG. 1. The pass-through allows the tools and/or accessories to be connected to the output shaft. The housing comprises a handle portion 104 that is adapted for gripping by a user. Accordingly, the power tool may be a handheld power tool. The power tool comprises an operating panel 108 for controlling an operation of the power tool. The operating panel may comprise one or more user input functionalities for receiving user input and one or more user output functionalities for providing information to a user regarding operation of the power tool. The one or more user input functionalities may be implemented by one or more user input devices. The one or more user output functionalities may be implemented by one or more user output devices. Examples of the user input devices comprise at least buttons 112 for receiving commands based on user touch. In an example at least one of the buttons may have a speed potentiometer. The speed potentiometer many dictate a target speed set by user. Examples of the output devices comprise at least lights 110, display devices, sound devices and speakers for communicating information to users. The user input devices may provide controlling the power tool, e.g. setting a speed, such as a maximum speed, of the power tool. The user output devices may provide presenting a motor speed of the power tool to the user.

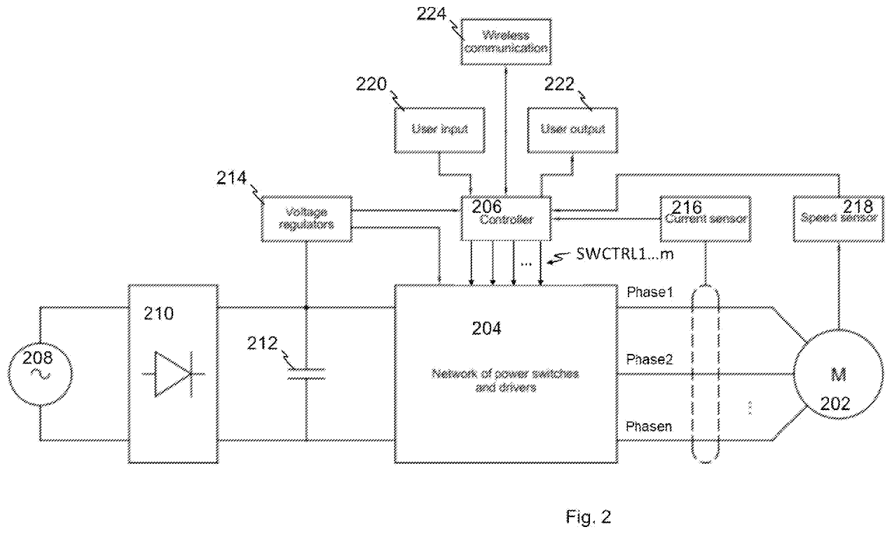

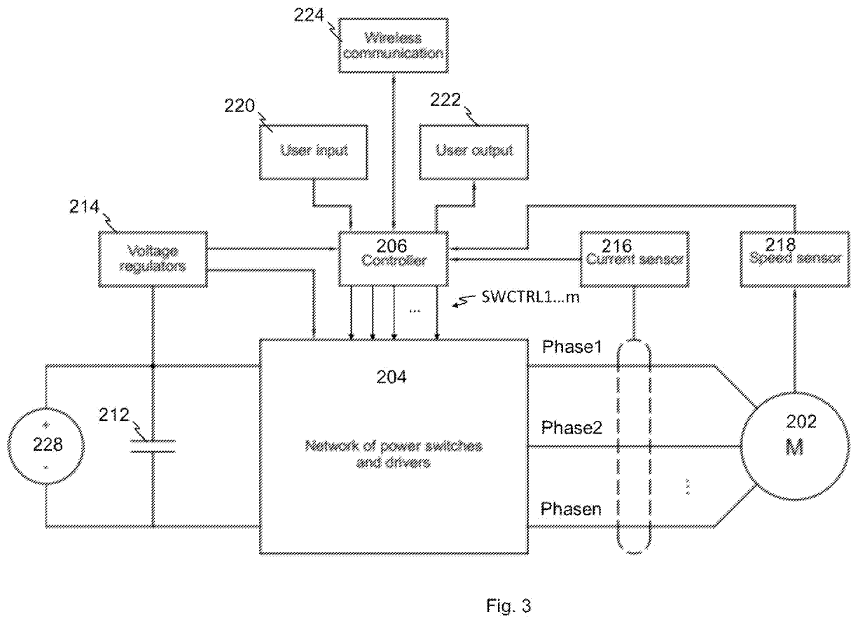

FIGS. 2 and 3 illustrate examples of block diagrams for apparatuses in accordance with at last some embodiments. The apparatuses may be power tools. The apparatuses provide controlling a speed of a motor 202 in a power tool for example described with FIG. 1. In an example, the motor may be a brushed DC (Direct Current) motor, a BLDC (Brushless DC) motor or some other form of Switched Reluctance Motor (SRM). A power switching network 204 is connected to the motor for driving the motor. The power switching network comprises gate drivers and switches in form of IGBTs or MOSFETs or the like. The power switching network may connect the motor by leads corresponding to each phase. Thus, the power switching network may be connected to an n-phase motor by leads corresponding to each phase, thus n leads, {Phase1, Phase2, . . . , Phasen}, where n is an integer for the number of phases. The power switching network comprises m switches and drive circuitries corresponding to each of the switches, where m is an integer for the number of switches. A controller 206 is connected to the power switching network for controlling the m switches. Accordingly, each switch may be connected by the controller by a corresponding lead, Switch Control (SWCTRL), {SWCTRL1, SWCTRL2, . . . , SWCTRLm}, from the controller. Examples of the controller comprise a Microcontroller (MCU), Field Programmable Gate Array (FPGA), an Application Specific Integrated Circuit (ASIC) and a processor.

In an example, the controller 206 is configured to control the switches of the power switching network based on speed control commands. The speed control commands may be used to generate Pulse-Width Modulation (PWM) values. At a given time instant, a PWM value generated based on a speed control command is mapped to the switches of the power switching network based on a commutation step and a switching pattern. In this way, the PWM value may be used to determine control signals to the SWCTRLs. The switching pattern may be e.g. asymmetric, symmetric, synchronous or semi-symmetric.

In an example, an AC (Alternating Current) voltage source 208 may be connected to a rectifier 210, e.g. a full bridge rectifier, for obtaining a DC voltage that may be used for powering the power switching network 204 and the controller 206. In an example, a rectified voltage from the rectifier 210 may be filtered by a capacitor 212 and fed to voltage regulators 214 for generating voltages that are fed to the controller 206 and the power switching network 204. In an example, the voltage regulators may feed 12 V to the power switching network and 3.3 V to the controller.

In an example, a DC voltage source 228, for example a battery, may be connected to a rectifier 210, e.g. a full bridge rectifier, for obtaining a DC voltage that may be used for powering the power switching network 204 and the controller 206.

A current sensor 216 may be connected to the controller 206 for measuring current values of current output from the power switching network and a speed sensor 218 may be connected to the controller for measuring a speed of the motor 202. The current sensor may be configured to measure a phase current of each phase connected to the motor. In an example, a phase current may be measured based on a single shunt resistor in a return path of each half-bridge of the power switching network. The speed sensor may be a dedicated sensor device or circuitry for measuring a back electromotive force of the motor (BEMF). Since the BEMF is directly proportional to speed of the DC motor, e.g. the BLDC motor, a speed of the motor may be determined based on the BEMF. The BEMF may be calculated based on a difference between a supplied voltage and a current loss. In an example, the BEMF may be determined based on measuring a voltage and current loss of two phases of a given commutation step.

In an example, the motor 202 may be a three phase BLDC motor, thus n is 3, whereby the power switching network comprises three half bridges consisting of m switches, or transistors, and drive circuitries for said switches. Since n=3 and m=2×n, m becomes 6. It should be noted that m=2×n is only an example that is valid in most cases and the relationship between m and n may be different depending on implementation. In another example, a single-phase BLDC motor may have n=2, whereby m becomes 4 using the above relationship between m and n.

In an example, the power tool may comprise one or more user input devices 220 and one or more user output devices 222. The one or more user input devices may be configured to implement one or more user input functionalities. The one or more user output devices may be configured to implement one or more user output functionalities. The user input devices may provide controlling the power tool, e.g. setting a speed, such as a maximum speed, of the power tool. The user output devices may provide presenting a motor speed of the power tool to the user.

In an example, the power tool may comprise a wireless communications module 224 connected to the controller. The wireless communications module enables reading data from the controller and writing data to the controller. Data written to the controller may comprise parameters for controlling a speed of the motor. Data read from the controller may comprise parameters for controlling a speed of the motor, measured current value(s) and measured motor speed value(s). Examples of the parameters for controlling a speed of the motor comprise at least one or more speed dependent current limit settings, a maximum motor speed and an idle speed of the motor. Examples of wireless communications technologies for implementing the wireless communications module 224 comprise at least Wi-Fi and Bluetooth Low Energy (BLE).

In an example, an apparatus in accordance with at least some embodiments comprises a controller 206 connected to a current sensor 216, a speed sensor 218 and a power switching network 204 for driving a motor. In some embodiments, the apparatus may comprise further devices examples of which are described in FIGS. 2 and 3.

In an example, an apparatus in accordance with at least some embodiments comprises a controller 206 configured to perform one or more functionalities described with a method according to an embodiment. For example, at least some of the blocks for the apparatus described in FIGS. 2 and 3 may be combined into a single block. In an example, some of the blocks described in FIGS. 2 and 3 may be combined into the controller 206. Examples of the controller comprise at least an MCU, an FPGA, an ASIC and a processor. The controller may be operatively connected to a memory. The memory may be a built-in or the memory may be external to the controller. the memory may store computer readable program code means that when executed by the controller cause one or more functionalities described with a method according to an embodiment.

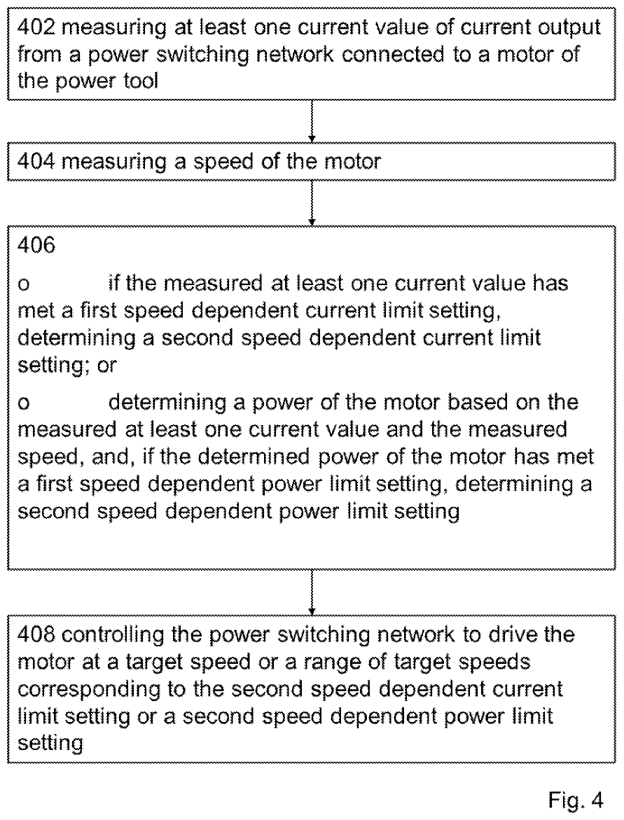

FIG. 4 illustrates a method for controlling speed of a motor of a power tool. The method provides controlling a speed of the motor, i.e. a motor speed control, at varying loads. Therefore, it not necessary for a user of the power tool to manually change a speed setting via an operating panel of the power tool when the power tool is used for working on an object. The method may be performed by a controller connected to a current sensor, a speed sensor and a power switching network for driving the motor, for example the controller 206 described with FIG. 2. the user does not have to control the speed via the operating panel of the power tool, but the speed may be decreased and increased based on changing the load applied on the power tool.

Phase 402 comprises measuring at least one current value output by a power switching network connected to a motor of the power tool. In an example, the controller may measure current values based on readings received from one or more speed sensors that are connected to phases of the motor.

Phase 404 comprises measuring a speed of the motor. In an example, the speed of the motor may be measured by the controller based on readings received from a speed sensor.

Phase 406 comprises determining, if the measured at least one current value has met a first speed dependent current limit setting, and if the measured at least one current value has met the first speed dependent current limit setting, determining a second speed dependent current limit setting; or determining a power of the motor based on the measured at least one current value and the measured speed, and, if the power of the motor has met a first speed dependent power limit setting, determining a second speed dependent power limit setting.

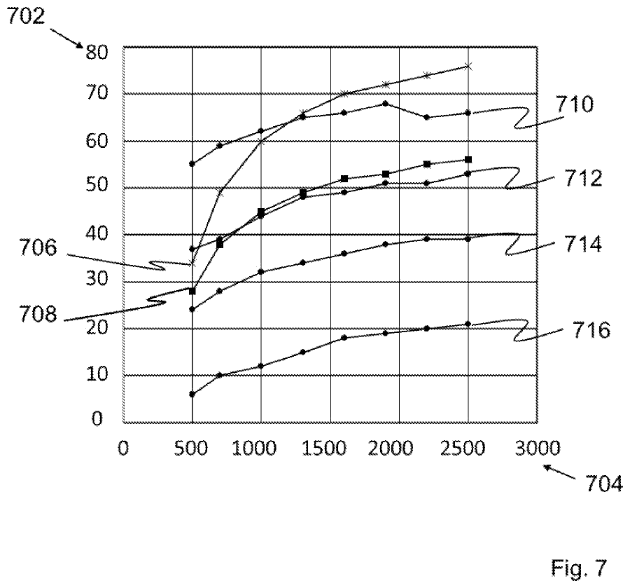

Phase 408 comprises controlling the power switching network to drive the motor at a target speed corresponding to the second speed dependent current limit setting or the second speed dependent power limit setting. In an example the second speed dependent current limit setting or the second speed dependent power limit setting may define the target speed that is different than a previous target speed defined by the first speed dependent current limit setting or the first speed dependent power limit setting. Accordingly, each target speed value may be associated with a speed dependent current limit setting or a speed dependent power limit setting. Examples of speed dependent current limit settings associated with target speeds are illustrated in FIG. 7. It should be note that although FIG. 7 shows current limit settings each of which comprising a higher speed dependent current limit and a lower speed dependent current limit, a current limit setting may be implemented based on a single current limit.

In an example, phase 408 comprises setting a speed control command for driving the motor at a target speed corresponding to the second speed dependent current limit setting or the second speed dependent power limit setting. Therefore, the target speed for driving the motor may be defined by setting the speed control command. The speed control command controls a current, and therefore also power, output by the power switching network. The speed control command (speed_cmd) may be a new value for a current speed control command (current_speed_cmd). The new speed control command may set based on the current speed control command by increasing, decreasing or maintaining the current speed control command as follows:

$$increasing the speed control command \text{:} speed\_cmd = current\_speed \_cmd + speed\_step \_inc$$

$$decreasing speed control command \text{:} speed\_cmd = current\_speed \_cmd - speed\_step \_dec$$

$$maintaining speed control command \text{:} speed\_cmd = current\_speed \_cmd ,$$

where speed_step_inc, i.e. increase step, is a value added to the current_speed_cmd for increasing the speed of the motor and speed_step_dec, i.e. decrease step, is a value added to the current_speed_cmd for decreasing the speed of the motor.

In an example, phase 406 comprises, determining that the motor is loaded and applying the motor speed control described with phase 408, if the motor is determined to be loaded. In an example, the motor is determined to be loaded, when the measured at least one current value has met a threshold value of the current, i.e. Ith_idle, when the motor is in idle mode. On the other hand, the motor may be determined to be in idle mode provided the measured at least one current value has not met the threshold value of the current, Ith_idle. In an example, the threshold value, Ith_idle, for the at least one current value may be determined to be higher than a range of current values of the motor, when the motor is driven unloaded, while also taking into account wear of the motor during use and over time. Accordingly, the threshold value of the current, Ith_idle, may be proportional to internal losses of the motor, when the motor is not loaded.

In an example, phase 406 comprises determining the first speed dependent current limit setting or the first speed dependent power limit setting based on the measured speed of the motor. In this way the first speed dependent current limit setting and the first speed dependent power limit setting may be defined as functions of the speed of the motor.

In an example phase 406 comprises selecting the second speed dependent current limit setting from more than one speed dependent current limit settings based on a comparison of distances between a range of current values of the second speed dependent current limit settings and the measured at least one current value. In an example, the range may be defined by a range associated with a single current limit value or the range may be between an upper current limit value and a lower current limit value.

In an example in accordance with at least some embodiments, phase 408 comprises using the second speed dependent current limit setting or the second speed dependent power limit setting for monitoring current output by the power switching network. In this way the speed dependent current limit setting and the speed dependent power limit setting may be updated, whereby the motor may be monitored based on the updated setting.

In an example in accordance with at least some embodiments, a slope of speed dependent current limit settings is decreasing, with increasing speed of the motor. In an example a speed dependent current limit setting may comprise an upper current limit value and a lower current limit value, whereby curve comprising two or more of upper current limit values and a curve comprising two or more lower current limit values have decreasing slopes. In an example, a speed dependent current limit setting comprises current limit values and associated current value ranges and a curve comprising two or more current limit values has a decreasing slope.

In an example in accordance with at least some embodiments, phase 408 comprises determining a user speed setting based on user input and controlling, if the measured speed of the motor has reached the user speed setting, the power switching network to drive the motor at the user speed setting. In this way the power switching network motor may continue driving the motor at the current speed of the motor and motor speed control based on the speed dependent current limit or speed dependent power limit may not be performed. In an example, the user input may be received via an operating panel of the power tool. In an example, the power switching network may be controlled based on setting a speed control command to the power switching network based on the user speed setting.

In an example in accordance with at least some embodiments, phase 408 comprises controlling the power switching network to drive the motor at an idle speed, if the measured at least one current value has not met a threshold value for the current, Ith_idle. In this way the motor may be determined to be idling and not loaded by external loads, e.g. the power tool is not used for working an object. It should be noted that on the other hand if the threshold value for the current, Ith_idle, has been met the phase 408 comprises controlling the power switching network to drive the motor based on the second speed dependent current limit setting or the second speed dependent power limit setting.

In an example in accordance with at least some embodiments, phase 408 comprises selecting a motor speed control mode to be a mode based on speed dependent current limit settings from at least two motor speed control modes for the motor. The motor speed control mode may be selected based on a user input received via an operating panel of the power tool. In an example the speed control modes may comprise the mode based on the speed dependent current limit settings and a mode based on a user speed setting. The speed control mode based on a user speed setting may be based on receiving the user speed setting for the motor speed via an operating panel of the power tool and controlling the motor to run at the motor speed received from the user. In an example, the speed control mode based on the speed dependent current limit settings may be based on enabling the mode based on a selection of a user that is received via the operating panel of the power tool. In an example, an operating panel of the power tool may comprise one or more devices for receiving user input for selecting one or more speed control modes of the motor and/or a user speed setting for the motor speed. Examples of the devices comprise at least buttons and potentiometers. It should be noted that a single user input or a combination of user inputs via the operating panel may be used to determine the speed control mode and/or a user speed setting for the motor. A speed control command for the power switching network may be set based on the user speed setting for controlling the speed of the motor or based on a speed dependent current limit setting. It should be noted that, alternatively or additionally to receiving the user input via the operating panel of the power tool, the user input may be received over a wireless connection. The wireless connection may be provided by a wireless communications module. In an example the user input over the wireless connection may be carried in a message comprising a command indicating, or corresponding, to the user input.

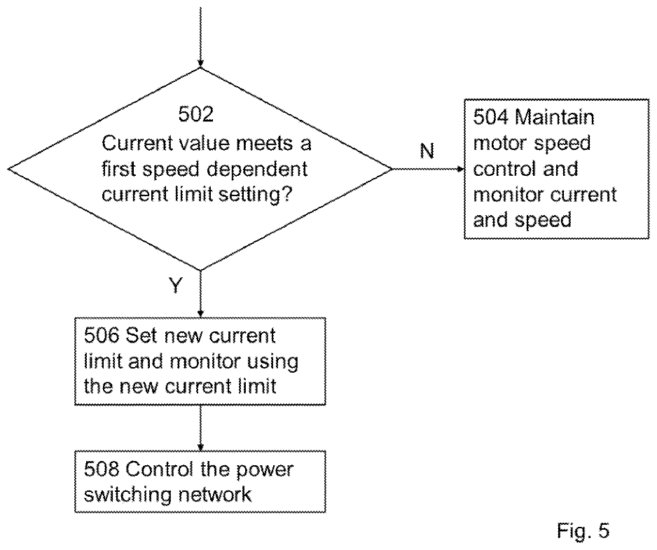

FIG. 5 illustrates a method for controlling speed of a motor of a power tool. The method provides controlling a speed of the motor, i.e. a motor speed control, at varying loads. Therefore, it not necessary for a user of the power tool to manually change a speed setting via an operating panel of the power tool when the power tool is used for working on an object. The method may be performed by a controller connected to a current sensor, a speed sensor and a power switching network for driving the motor, for example the controller 206 described with FIG. 2, for example, in connection with phases 404 and 406 in FIG. 4.

Phase 502 comprises determining, if the measured at least one current value has met a speed dependent current limit setting.

Phase 504 comprises controlling, if the measured at least one current value fails to meet a speed dependent current limit setting, the power switching network to maintain the speed of the motor and monitoring the current output from the power switching network and the speed of the motor. In an example a speed control command to the power switching network may be maintained and the current and speed may be measured in accordance with phases 402 and 404.

Phase 506 comprises setting, if the measured at least one current value has met a speed dependent current limit setting corresponding to the measured speed of the motor, a new speed dependent current limit setting as the speed dependent current limit setting, and monitoring, the speed of the motor and current output from the power switching network, based on the set speed dependent current limit setting, i.e. the new speed dependent current limit setting. In this way the speed dependent current limit setting may be updated.

Phase 508 may comprise controlling the power switching network to drive the motor at the target speed of the motor based on the set speed dependent current limit setting. In this way the target speed of the motor may be controlled based on the new speed dependent current limit setting. In an example in accordance with at least some embodiments phase 508 comprises increasing the target speed of the motor if it is determined in phase 502 that the measured at least one current value has met the first speed dependent current limit setting. In an example in accordance with at least some embodiments phase 508 comprises decreasing the target speed of the motor if it is determined in phase 502 that the measured at least one current value does not meet the speed dependent current limit setting. It should be noted that the controlling of the power switching network may be performed in accordance with described in phase 408, for example by setting a speed control command.

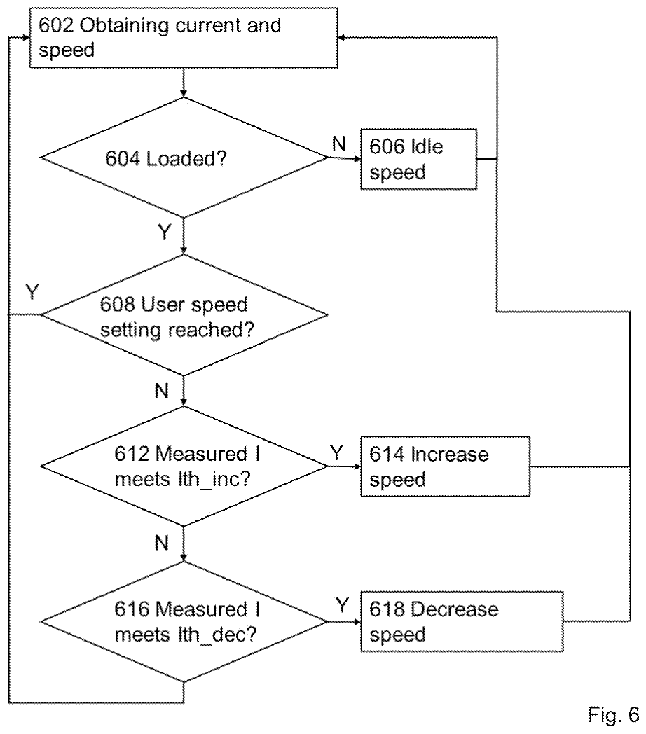

FIG. 6 illustrates an example of a method for controlling speed of a motor of a power tool in accordance with at least some embodiments. The method provides controlling a speed of the motor, i.e. a motor speed control, at varying loads. Therefore, it not necessary for a user of the power tool to manually change a speed setting via an operating panel of the power tool when the power tool is used for working on an object. The method may be performed by a controller connected to a current sensor, a speed sensor and a power switching network for driving the motor, for example the controller 206 described with FIG. 2.

Phase 602 comprises obtaining information of current fed to the motor and a speed of the motor. The current and speed may be measured in accordance to described with phases 402 and 404 of FIG. 4.

Phase 604 comprises determining whether the motor of the power tool is loaded or not. When the motor is loaded, the power tool may be on a surface of an object and tools and/or accessories operatively connected to a motor output shaft of the power tool may be in contact with the object and driven by the motor. In this position, the motor is loaded by forces caused by the contact to the object and the object may be worked by a movement of the tools and/or accessories based on the torque from the motor. In an example, in accordance with at least some embodiments, phase 604 comprises determining whether the measured at least one current value has met a threshold value of the current, Ith_idle. If in phase 604 it is determined that the threshold value for the current has been met, it may be determined that the motor is loaded, and the method may proceed to phase 608 for driving the motor based on a speed dependent current limit setting or based on a user speed setting. Otherwise, in phase 604, the method may proceed to phase 606. Phase 606 comprises controlling the power switching network to drive the motor at an idle speed. In an example, in phase 606 a user speed setting of the motor may have been set by a user for example via a user interface of the power tool. The user interface of the power tool may be provided by an operating panel. However in phase 606, instead of causing the power switching network to drive the motor at a speed according to the user speed setting, the power switching network is caused to drive the motor at the idle speed.

Phase 608 comprises determining whether a motor speed according to the user speed setting has been reached. In an example, the user speed setting may be set by a user for example via a user interface of the power tool. The user interface of the power tool may be provided by an operating panel. If the motor speed has reached the user speed setting, a target speed for the motor may be maintained, and method may proceed to phase 602. If the user speed setting has not been reached the method may proceed to phase 612 for determining a whether the speed dependent current limit has been met. In an example, the target speed of the motor may be maintained, when a current speed control command to the power switching network is not changed.

Phase 612 comprises determining if the measured at least one current value has met a higher current limit, Ith_inc, of a speed dependent current limit setting. In this way, it may be determined whether the speed of the motor should be increased.

Phase 614 comprises increasing the target speed of the motor if it is determined in phase 612 that the measured at least one current value has met the higher current limit, Ith_inc. In an example, in phase 614, the target speed may be increased in steps, e.g. increased by one step each time the phase is performed. An increase step may be determined based on the measured at least one current value and the current speed control command to the power switching network may be increased by the determined increase step. Accordingly, in phase 614, a current speed control command may be increased by the determined increase step. In an example, phase 614 comprises determining the target speed of the motor based on the measured at least one current value and setting a speed control command to the power switching network for increasing the speed of the motor based on the determined target speed. In phase 612, if the measured at least one current value has not met the higher current limit, the method may proceed to phase 616.

Phase 616 comprises determining if the measured at least one current value has met a lower current limit, Ith_dec, of the speed dependent current limit setting. In this way a need to decrease the speed of the motor may be determined.

Phase 618 comprises decreasing the target speed of the motor if it is determined in phase 616 that the measured at least one current value has met the lower current limit, Ith_dec. In an example, in phase 618, the target speed may be decreased in steps. A decrease step may be determined based on the measured at least one current value and a current speed control command to the power switching network may be decreased by the determined decrease step. Accordingly, in phase 618, a current speed control command may be decreased by the determined decrease step. In an example, phase 616 comprises determining the target speed of the motor based on the measured at least one current value and setting a speed control command to the power switching network for decreasing the speed of the motor based on the determined target speed. In phase 616, if the measured at least one current value has not met the lower current limit, the method may proceed to phase 602.

In an example, phase 618 comprises maintaining the target speed above the idle speed, when the motor is loaded. In this way output power of the power tool may be maintained at a level for allowing rotation of the output shaft at a speed that is at least the idle speed, when the motor is loaded. Accordingly, the output power can be maintained at a sufficient level for working on an object by the power tool. In an example, in phase 618, the target speed is not decreased below an offset idle speed:

$$target\_speed = idle\_speed + offset ,$$

wherein the offset is a value added to the idle speed for maintaining the target speed above the idle speed. In an example, in phase 618, a speed control command to the power switching network may be set to a value corresponding to the idle_speed+offset. In an example, the idle speed, i.e. idle_speed, may be 500 rpm and the offset may be 200 rpm, whereby the target speed, i.e. target_speed, in is set to 700 rpm and the speed control command may be set to a value corresponding to 700 rpm. It should be noted that the offset may be set according to application of the power tool. For example, the offset may depend on the weight of the power tool, friction between the power tool and a surface of the object on which the power tool is positioned, resolution of measured speed, resolution of measured current and/or a minimum PWM value for causing a rotation of the motor. For example, the idle speed may be set based on application. The idle speed may be e.g. set to a minimum speed or to a somewhat higher speed than the minimum speed. Setting the idle speed higher than the minimum speed enables detecting an idle mode of the motor.

FIG. 7 illustrates an example of speed dependent current limit setting and measured current values at defined speeds of a motor of a power tool in accordance with at least some embodiments. The speed dependent current limit setting comprises a higher speed dependent current limit 706 and a lower speed dependent current limit 708 corresponding to a plurality of speeds. Accordingly, the higher speed dependent current limit 706 and lower speed dependent current limit 708 may be curves with respect to speed values. The higher speed dependent current limit 706 and lower speed dependent current limit 708 define a range of current values between the higher speed dependent current limit 706 and lower speed dependent current limit 708. Referring to FIG. 6, when both phases 612 and 616 are determined negatively, the measure current is at the range, i.e. between the higher speed dependent current limit 706 and lower speed dependent current limit 708. However, it is feasible that the speed dependent current limit comprises a single speed dependent current limit.

In FIG. 7, current values 702 of the speed dependent current limits 706, 708 and measured current values are shown corresponding to values of speed 704 of the motor. The measured current values are illustrated for four load scenarios for the motor of the power tool by corresponding curves for current values at different speeds. Curves corresponding to the first, second and third load scenarios describe current values measured at speeds, when the motor is loaded by the power tool being pressed by various loads against a surface of a worked object. Curve corresponding to the fourth load scenario describe current values measured at speed, when the motor is unloaded. In the curve corresponding to a first load scenario 710, the motor of the power tool is loaded by the weight of the power tool and an additional weight of 4.1 kg on the power tool. In the curve corresponding to a second load scenario 712, the motor of the power tool is loaded by the weight of the power tool and an additional weight of 1.6 kg on the power tool. In the curve corresponding to a third load scenario 714, the motor of the power tool is loaded by the weight of the power tool without additional weights put on the power tool. In the curve corresponding to a fourth load scenario 716, the motor of the power tool is not loaded by external loads, whereby the power tool is off the object. The current values of the curves 710, 712, 714 and 716 and the speed dependent current limits 706, 708 may be used in the methods of FIGS. 4, 5 and 6 for controlling speed of the motor.

In an example in accordance with at least some embodiments, the speed dependent current limit setting comprises a higher speed dependent current limit 706 and a lower speed dependent current limit 708 corresponding to a plurality of speeds. The higher speed dependent current limit has a larger slope than the lower speed dependent current limit. In this way a threshold to increase the speed in a method for controlling speed of the motor, e.g. in phases 612 and 614, may be higher than the threshold to decrease the speed, e.g. in phases 616 and 618. In an example the slope may be determined based on a slope from a current value of the speed dependent current limit at one speed to a higher speed. In another example the slope may be determined based on a slope from a current value of the speed dependent current limit at one speed to a lower speed.

In an example in accordance with at least some embodiments for controlling motor speed of a power tool, the motor speed is controlled based on at least two speed dependent current limit settings and each of the speed dependent current limit settings comprise a range of current values between a higher current limit 706 and a lower current limit 708. In an example, a difference between the higher current limit 706 and the lower current limit may be increasing with increasing speed values. In an example a target speed corresponding to a current limit setting may be a speed value at which a current value of the motor is at a current value range corresponding to the speed dependent current limit setting. In an example, the current value range may comprise current values between the higher current limit and the lower current limit. In another example the current values range may be a range of current values defined for a specific speed of the motor.

In an example in accordance with at least some embodiments for controlling motor speed of a power tool, the motor speed is controlled based on at least two speed dependent power limit settings and each of the dependent power limit settings comprise a range of power values between a higher power limit 706 and a lower power limit 708. In an example, a difference between the higher power limit 706 and the lower power limit may be increasing, e.g. linearly, with increasing speed values.

In an example in accordance with at least some embodiments, the power tool may be a polisher. The polisher has a polishing pad that is attached to the polisher to be driven by the motor. Polishing compound may be applied to the polishing pad for polishing an object by the polisher. Referring to FIGS. 6 and 7, the motor speed of the polisher may be controlled based on speed dependent current limits or speed dependent power limits. At startup, the power switching of the polisher is controlled to drive the polisher at an idle speed, e.g. 500 rpm. At the idle speed, before the motor is loaded by applying the polishing pad on a surface of the polished object, the speed is sufficiently small that the polishing compound may be applied to the polishing pad without splashing the polishing compound to the surroundings. Once the polishing pad is placed on the surface of the polished object, the polishing pad contacts the surface of the polished object, and the motor is loaded in accordance to described with phases 602 and 604. When the motor is loaded, current fed to the motor by the power switching network is increased to a level that exceeds the Ith_idle, the threshold value of the current may be determined to have been met. Therefore, the motor is loaded, and the method may proceed from phase 604 to phase 612 for controlling the motor speed based on a speed dependent current limit setting or a speed dependent power limit setting in phases 614 and 618. In an example, the speed dependent current limit setting may comprise a higher speed dependent current limit and a lower speed dependent current limit, whereby phase 612 may comprise comparing the measured at least one current value with the higher speed dependent current limit and phase 616 may comprise comparing the measured at least one current value with the lower speed dependent current limit. Referring to the examples of current values in load scenarios 710, 712, 714 and 716 in FIG. 7 and the speed dependent current limits 706, 708, the measured current values may be increased based on the load applied to the power tool which increases the load of the motor. Therefore, increasing the load of the power tool causes an increase of the measured current values and once the measured at least one current value is higher than the higher speed dependent current limit, e.g. in the load scenario 710 at speed 1000, the method may proceed from phase 612 to phase 614. On the other hand, referring to FIG. 7 and the load scenarios 710, 712, 714 and 716, the measured current values may be decreased based on the load applied to the power tool which decreases the load of the motor. Therefore, decreasing the load of the power tool causes a decrease of the measured current values and once the measured at least one current value is less than the lower speed dependent current limit, e.g. in the load scenario 712 at speed 2000, the method may proceed from phase 616 to phase 618. Therefore, the motor speed control based on the speed dependent current limit setting, or the speed dependent power limit setting facilitates controlling speed of the motor based on the load applied to the power tool. Therefore, thanks to the speed dependent current limit setting and speed dependent power limit setting the user does not have to control the speed via the operating panel of the power tool, but the speed may be decreased and increased based on changing the load applied on the power tool.

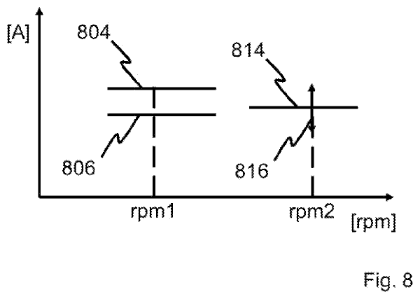

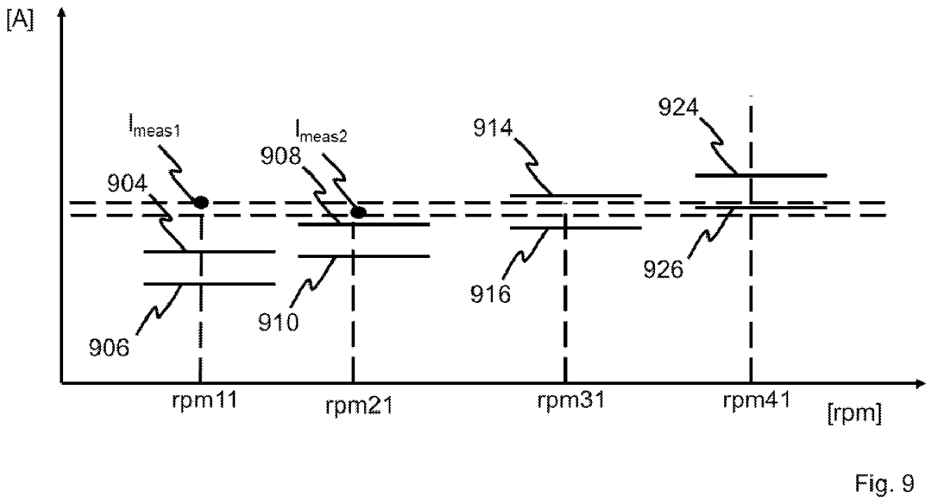

FIG. 8 illustrates examples of speed dependent settings in accordance with at least some embodiments. The speed dependent settings may be speed dependent current limit settings or speed dependent power limit settings. The examples are illustrated with reference to a y-axis representing values of current in Amperes, [A], and an x-axis representing values of motor speed in rotations per minute, [rpm]. In a first example illustrated in FIG. 8, a speed dependent setting, here a speed dependent current limit setting, comprises an upper current limit value 804 and a lower current limit value 806 for a current value output from a power switching network. The speed dependent current limit setting is dependent on motor speed such that the speed dependent current limit setting, e.g. the upper current limit and the lower limit, may be defined based on a measured speed of the motor at a given time, when the motor is being driven. Accordingly, a motor speed or a range of motor speeds may have a specific speed dependent current limit setting. In the illustrated example, the speed dependent current limit setting corresponding with motor speed “rpm1” has the upper current limit value 804 and the lower current limit value 806. The upper current limit value 804 may be used for Ith_inc in phase 612 and the lower current limit value 806 may be used for Ith_dec in phase 616. In a second example illustrated in FIG. 8, a speed dependent setting, here speed dependent current limit setting, comprises a single limit value 814 and a range 816 of current values for a current value output from a power switching network. The speed dependent current limit setting is dependent on speed such that the speed dependent current limit setting, e.g. the single limit value, may be defined based on a speed of the motor. Accordingly, each motor speed or a range of motor speeds may have a specific speed dependent current limit setting. Accordingly, the speed dependent current limit setting corresponding with motor speed “rpm2” has the limit value 814 and the range 816 of current values defined based on the limit value. In an example, the range of current values may be defined by an upper current limit and a lower limit, whereby the upper current limit exceeds the single limit value and the lower limit value is less than the single limit value. It should be noted that the range 816 defined by the upper current limit and lower limit may be symmetrical or asymmetrical with respect to the single limit value 814. The upper current limit of the range 816 may be used for Ith_inc in phase 612 and the lower limit of the range 816 may be used for Ith_dec in phase 616 similar to described above. It should be noted that a speed dependent setting corresponds with a target speed of the motor, whereby if a current value measured from a power switching network has met the speed dependent setting, the target speed may be increased, whereby a new, or updated, speed dependent setting that has a corresponding target speed, may be determined for controlling motor speed. On the other hand, a speed dependent setting corresponds with a target speed of the motor, whereby if a current value measured from a power switching network has not met the speed dependent setting, the target speed may be decreased, whereby a new, or updated, speed dependent setting that has a corresponding target speed, may be determined for controlling motor speed. FIG. 9 illustrates an example of controlling the power switching network to drive the motor at a target speed corresponding to a speed dependent current limit in accordance with at least some embodiments. The target speed of the motor may correspond to a speed dependent power limit setting that comprises an upper current limit value and a lower limit value for example in accordance to described with FIG. 8. The controlling may be performed in accordance to described with the method described with FIG. 4. Iₘₑₐₛ₁ and Iₘₑₐₛ₂ are measured current values in accordance with phase 402 at measured speeds of the motor in accordance with phase 404. A speed dependent current limit setting corresponding to a speed of the motor has an upper current limit value 904, 908, 914, 924 for the current output from a power switching network and a lower limit value 906, 910, 916, 926 for the current output from a power switching network. The upper current limit value and lower current limit value define a range for current values corresponding to a given speed of the motor, “rpm11”, “rpm21”, “rpm31”, “rpm41”. If the measured current value, e.g. Iₘₑₐₛ₁ and Iₘₑₐₛ₂, is not within the range, thus the measured current value falls outside of the range of current values defined between the upper current limit value and the lower limit value of the current limit setting, the speed dependent current limit setting that is currently being used has been met and a new, or a second, or another, speed dependent current limit setting may be determined, in accordance to described with phase 406, whereby the power switching network may be controlled to drive the motor in accordance with phase 408.

In an example, Iₘₑₐₛ₁ is measured at “rpm11” of the motor and the Iₘₑₐₛ₁ meets the speed dependent current limit setting corresponding to “rpm11” since the Iₘₑₐₛ₁ is outside of the range of current values between the upper current limit value 904 and the lower limit value 906. Then, a second speed dependent current limit setting may be determined in accordance to described with phase 406, whereby the power switching network may be controlled to drive the motor in accordance with phase 408. The second speed dependent current limit setting may correspond to a given speed of the motor, “rpm11”, “rpm21”, “rpm31”, “rpm41”.

In an example, the second speed dependent current limit setting may be determined based on the measured current value Iₘₑₐₛ₁ based on calculating the second speed dependent current limit setting from the measured current value Iₘₑₐₛ₁ based on one or more linear functions or non-linear functions of the measured current values and the measured speed [rpm]. Accordingly, the second speed dependent current limit setting may follow at least one linear or non-linear function. The at least one linear or non-linear function may be designed based on current value ranges of the speed dependent power limit settings and speeds of change, or slopes, of the upper current limit and a lower current limit. For example, at low speeds of the motor, a range of current values between an upper current limit and a lower current limit may be smaller than a range of current values between an upper current limit and a lower current limit at high speeds of the motor. Furthermore, the slopes of the upper current limit and the lower current limit may be decreasing, with increasing speed of the motor. Examples of the slopes are illustrated by the speed dependent current limits 706, 708 that have slopes decreasing with increasing speed of the motor.

In another example, the second speed dependent current limit setting may be determined based on one or more pre-calculated tables. The one or more pre-calculated tables may be used to lookup a speed dependent current limit value corresponding to a measured current value Iₘₑₐₛ₁, Iₘₑₐₛ₂ and a measured speed of the motor [rpm] stored to the one or more pre-calculated tables. Similarly, as described above with calculating the second speed dependent current limit setting from the measured current value Iₘₑₐₛ₁ based on one or more linear functions or non-linear functions, also second speed dependent current limit settings determined based on the one or more pre-calculated tables may have decreasing slopes at the upper current limit and the lower current limit, with increasing speed of the motor.

In another example, the second speed dependent current limit setting may be determined based on one or more stepwise changes of the speed dependent current limit setting that is currently being used. A stepwise change may increment or decrement the target speed of the motor, whereby each step may define a new target speed and a speed dependent power limit setting corresponding to the new target speed. Similarly, as described above with calculating the second speed dependent current limit setting from the measured current value Iₘₑₐₛ₁ based on a linear function or a non-linear function, also second speed dependent current limit settings determined based on the stepwise changes may have decreasing slopes at the upper current limit and the lower current limit, with increasing speed of the motor.

In an example, a first current limit setting may correspond with “rpm11” and the second current limit setting may be at least one of the speed dependent current limit settings at “rpm21”, “rpm31” and “rpm41”. Considering that the second speed dependent current limit setting comprises the current limit setting at “rpm21” and is used for controlling the power switching network to drive the motor. Then, if a measured current value Iₘₑₐₛ₂ of the power switching network at motor speed “rpm21” falls outside of the range of current values defined between the upper current limit value 908 and the lower current limit value 910 of the current limit setting, the speed dependent current limit setting for “rpm21” is met, and a new, or a further second, or another, speed dependent current limit setting may be determined, in accordance to described with phase 406.

In an example in accordance with at least some embodiments, a second speed dependent current limit setting may be selected from more than one speed dependent current limit settings based on a comparison of distances between a range of current values of the second speed dependent current limit settings and the measured at least one current value. In an example, a first current limit setting may correspond with “rpm11” and the second current limit setting may be at least one of the speed dependent current limit settings at “rpm21”, “rpm31” and “rpm41”. The second speed dependent current limit setting for controlling the power switching network to drive the motor may be selected from more than one speed dependent current limit settings based on a comparison of distances between the upper current limit value and lower current limit value to Iₘₑₐₛ₁ for each speed dependent current limit setting and the speed dependent current limit setting, where the distance of Iₘₑₐₛ₁ to the upper current limit value and the lower current limit value is the largest may be selected as the second current limit setting. The speed dependent current limit settings for the comparison may be selected based on the determining those speed dependent current limit settings, at “rpm31” and at “rpm41”, where Iₘₑₐₛ₁ falls within a range of current values defined between an upper current limit value and a lower current limit value of the speed dependent current limit setting. Accordingly, in the example of FIG. 9 the speed dependent current limit settings at “rpm31” and “rpm41” may be compared with Iₘₑₐₛ₁. The Iₘₑₐₛ₁ is closer to the upper current limit value 914 at “rpm31” than the lower limit value 916 at “rpm31”. On the other hand, the Iₘₑₐₛ₁ is closer to the lower limit value 926 than the upper current limit value 924 at “rpm41”. If the distance between Iₘₑₐₛ₁ and the upper current limit value 914 is smaller than the distance between Iₘₑₐₛ₁ and the lower limit value 926, the speed dependent current limit settings at “rpm41” is selected as the second speed dependent current limit setting. Otherwise, the dependent current limit setting at “rpm31” is selected as the second speed dependent current limit setting. In this way the speed dependent current limit setting, where the Iₘₑₐₛ₁ is positioned furthest from limits of the range may be selected as the second speed dependent current limit setting.

It should be noted that although the foregoing embodiments have been described with reference to speed dependent current limit setting. However, instead of the speed dependent current limit setting, speed dependent power limit setting may be used. Whereas the speed dependent current limit setting uses measured current values and one or more current limits for controlling speed of the motor, the speed dependent power limit setting uses the measured current values to determine corresponding power values. The power values and one or more power limits may be used to replace the current values and one or more current limits for controlling a speed of the motor in various examples described herein.

It should be noted that whereas the current limit setting described in the foregoing embodiments may be non-linear with respect to the speed of the motor. e.g. the current limits described in FIG. 7, the speed dependent power limit setting may be linear with respect to the speed of the motor.

In an example in accordance to at least some of the foregoing embodiments, when the speed dependent power limit setting is used instead of the speed dependent power limit setting, the measured current values may be used for determining power values of the motor. The power values may be used at least for determining whether the speed dependent power limit setting has been met. The power values may be determined by

$${P}_{meas} = speed \times {I}_{meas} ,$$

where Pₘₑₐₛ is a power value for the measured power, Iₘₑₐₛ is a measured current value and speed if is the speed of the motor of the power tool.

Embodiments may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any media or means that can contain, store, communicate, propagate or transport the instructions for use by or in connection with an instruction execution system, apparatus, or device, such as a computer.

Reference to, where relevant, “computer-readable storage medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialized circuits such as field programmable gate arrays FPGA, application specify circuits ASIC, signal processing devices and other devices. References to computer readable program code means, computer program, computer instructions, program instructions, instructions, computer code etc. should be understood to express software for a programmable processor firmware such as the programmable content of a hardware device as instructions for a processor or configured or configuration settings for a fixed function device, gate array, programmable logic device, etc.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

Reference signs

| | |
|---|---|
| 102 | Housing |
| 104 | Handle portion |
| 108 | Operating panel |
| 110 | Lights |
| 112 | Buttons |
| 202 | Motor |
| 204 | Power switching network |
| 206 | Controller |
| 208 | AC voltage source |
| 210 | Rectifier |
| 212 | Capacitor |
| 214 | Voltage regulators |
| 216 | Current sensor |
| 218 | Speed sensor |
| 220 | User input devices |
| 222 | User output devices |
| 224 | Wireless communications module |
| 228 | DC voltage source |
| 402, 404, | Phases of the method of FIG. 4 |
| 406, 408 | |
| 502, 504, | Phases of the method of FIG. 5 |
| 506, 508 | |
| 602, 604, | Phases of the method of FIG. 6 |
| 606, 608, | |
| 612, 614, | |
| 616, 618 | |
| 702 | Current values |
| 704 | Speed values |
| 706, 708 | Speed dependent current limit |
| 710, 712, | Load scenarios |
| 714, 716 | |
| 804 | Upper current limit value |
| 806 | Lower current limit value |
| 814 | Single limit value |
| 816 | Range of current values |
| 904 | Upper current limit value |
| 906 | Lower limit value |
| 908 | Upper current limit value |
| 910 | Lower limit value |
| 914 | Upper current limit value |
| 916 | Lower limit value |
| 924 | Upper current limit value |
| 926 | Lower limit value |

1. A method for controlling motor speed of a power tool, comprising:
measuring at least one current value of current output from a power switching network connected to a motor of the power tool;
measuring a speed of the motor; and
if the measured at least one current value has met a first speed dependent current limit setting, determining a second speed dependent current limit setting; or
determining a power of the motor based on the measured at least one current value and the measured speed, and, if the determined power of the motor has met a first speed dependent power limit setting, determining a second speed dependent power limit setting; and
controlling the power switching network to drive the motor at a target speed corresponding to the second speed dependent current limit setting or the second speed dependent power limit setting; wherein each of the first speed dependent current limit setting and the second speed dependent current limit setting comprise a range of current values between a higher current limit and a lower current limit, and the second speed dependent current limit setting is determined based on the measured at least one current value and whether the lower current limit or higher current limit has been met; or wherein each of the first speed dependent power limit setting and the second speed dependent power limit setting comprise a range of power values between a higher power limit and a lower power limit, and the second speed dependent power limit setting is determined based on the determined power and whether the lower power limit or higher power limit has been met.

2. The method according to claim 1, comprising:
determining the first speed dependent current limit setting or the first speed dependent power limit setting based on the measured speed of the motor; and
using the second speed dependent current limit setting or the second speed dependent power limit setting for monitoring current output by the power switching network.

3. The method according to claim 1, comprising:
increasing the target speed of the motor if the measured at least one current value has met the first speed dependent current limit setting; or
increasing the target speed of the motor if the determined power has met the first speed dependent power limit setting.

4. The method according to claim 1, comprising:
decreasing the target speed of the motor if the measured at least one current value does not meet the first speed dependent current limit setting; or
decreasing the target speed of the motor if the determined power does not meet the first speed dependent power limit setting.

5. The method according to claim 1, comprising:
maintaining the target speed above an idle speed, when the motor is loaded.

6. The method according to claim 1, comprising:
controlling the power switching network to drive the motor at an idle speed if the measured at least one current value has not met a threshold value for the current; and
controlling the power switching network to drive the motor based on the first speed dependent current limit setting, if the measured at least one current value has met the threshold value for the current; or
controlling the power switching network to drive the motor based on the first speed dependent power limit setting, if the determined power has met a threshold value for the power.

7. The method according to claim 1, comprising:
determining a user speed setting based on user input; and
maintaining the target speed, if the measured speed of the motor has reached the user speed setting.

8. The method according to claim 1, comprising:
selecting a motor speed control mode to be a mode based on speed dependent current limit settings from at least two motor speed control modes for the motor based on a user input received via an operating panel of the power tool or a user input over a wireless connection; or
selecting a motor speed control mode to be a mode based on speed dependent power limit settings from at least two motor speed control modes for the motor based on a user input received via an operating panel of the power tool a user input over a wireless connection.

9. The method according to claim 1, comprising:
selecting the second speed dependent current limit setting from more than one speed dependent current limit settings based on a comparison of distances between a range of current values of the second speed dependent current limit settings and the measured at least one current value.

10. The method according to claim 1, wherein the first speed dependent current limit setting and the second speed dependent current limit setting follow a curve and a slope of the curve is decreasing, with increasing speed of the motor.

11. A power tool comprising a controller connected to a current sensor, a speed sensor and a power switching network for driving a motor, wherein the power tool is configured to:
measure, by the controller, at least one current value of current output from a power switching network connected to a motor of the power tool;
measure, by the controller, a speed of the motor; and
determine, by the controller, if the measured at least one current value has met a first speed dependent current limit setting, and if the first speed dependent current limit setting has been met, determining a second speed dependent current limit setting; or
determine, by the controller, a power of the motor based on the measured at least one current value and the measured speed, and, if the determined power of the motor has met a first speed dependent power limit setting, determining a second speed dependent power limit setting; and
control, by the controller, the power switching network to drive the motor at a target speed corresponding to the second speed dependent current limit setting or the second speed dependent power limit setting; wherein each of the first speed dependent current limit setting and the second speed dependent current limit setting comprise a range of current values between a higher current limit and a lower current limit, and the second speed dependent current limit setting is determined based on the measured at least one current value and whether the lower current limit or higher current limit has been met; or wherein each of the first speed dependent power limit setting and the second speed dependent power limit setting comprise a range of power values between a higher power limit and a lower power limit, and the second speed dependent power limit setting is determined based on the determined power and whether the lower power limit or higher power limit has been met.

12. The power tool according to claim 11, wherein the power tool is a polisher, sander, grinder, screwdriver, impact driver, drill, circular saw, chain saw or jack hammer.

13. An apparatus comprising at least one controller and at least one memory storing instructions that, when executed by the at least one controller, cause the apparatus to perform at least:
measuring at least one current value of current output from a power switching network connected to a motor of a power tool;
measuring a speed of the motor; and
means-fer determining, if the measured at least one current value has met a first speed dependent current limit setting, and if the measured at least one current value has been met, determining a second speed dependent current limit setting; or
means-fer determining a power of the motor based on the measured at least one current value and the measured speed, and, if the determined power of the motor has met a first speed dependent power limit setting, determining a second speed dependent power limit setting; and
controlling the power switching network to drive the motor at a target speed corresponding to the second speed dependent current limit setting or the second speed dependent power limit setting; wherein each of the first speed dependent current limit setting and the second speed dependent current limit setting comprise a range of current values between a higher current limit and a lower current limit, and the second speed dependent current limit setting is determined based on the measured at least one current value and whether the lower current limit or higher current limit has been met; or wherein each of the first speed dependent power limit setting and the second speed dependent power limit setting comprise a range of power values between a higher power limit and a lower power limit, and the second speed dependent power limit setting is determined based on the determined power and whether the lower power limit or higher power limit has been met.

14. (canceled)

15. The apparatus of claim 12, wherein the apparatus is caused to perform:
determining the first speed dependent current limit setting or the first speed dependent power limit setting based on the measured speed of the motor; and
using the second speed dependent current limit setting or the second speed dependent power limit setting for monitoring current output by the power switching network.

16. The apparatus of claim 12, wherein the apparatus is caused to perform:
maintaining the target speed above an idle speed, when the motor is loaded.

17. The apparatus of claim 12, wherein the apparatus is caused to perform:
controlling the power switching network to drive the motor at an idle speed if the measured at least one current value has not met a threshold value for the current; and
controlling the power switching network to drive the motor based on the first speed dependent current limit setting, if the measured at least one current value has met the threshold value for the current; or
controlling the power switching network to drive the motor based on the first speed dependent power limit setting, if the determined power has met a threshold value for the power.

18. The apparatus of claim 12, wherein the apparatus is caused to perform:
determining a user speed setting based on user input; and
maintaining the target speed, if the measured speed of the motor has reached the user speed setting.

19. The apparatus of claim 12, wherein the apparatus is caused to perform:
selecting a motor speed control mode to be a mode based on speed dependent current limit settings from at least two motor speed control modes for the motor based on a user input received via an operating panel of the power tool or a user input over a wireless connection; or
selecting a motor speed control mode to be a mode based on speed dependent power limit settings from at least two motor speed control modes for the motor based on a user input received via an operating panel of the power tool a user input over a wireless connection.

20. The apparatus of claim 12, wherein the apparatus is caused to perform:
selecting the second speed dependent current limit setting from more than one speed dependent current limit settings based on a comparison of distances between a range of current values of the second speed dependent current limit settings and the measured at least one current value.

21. The apparatus of claim 12, wherein the apparatus is caused to perform, wherein the first speed dependent current limit setting and the second speed dependent current limit setting follow a curve and a slope of the curve is decreasing, with increasing speed of the motor.
